(19) United States
(12) Patent Application Publication
(10) Pub. No.: US 2001/0005380 A1
(43) Pub. Date: Jun. 28, 2001

(54) Network node for switching digital information of different protocol types

(76) Inventor: Bernd X. Weis, Korntal (DE)

Correspondence Address: SUGHRUE, MION, ZINN, MACPEAK & SEAS, PLLC, 2100 Pennsylvania Avenue, Washington, DC, 20037-3213, US

(21) Appl. No.: 09/733,903

(22) Filed: Dec. 12, 2000

(30) Foreign Application Priority Data
Dec. 28, 1999 (DE) 19961269.2

(51) Int. Cl. H04L 12/28; H04L 12/56

(52) U.S. Cl. 370/466; 370/419

(57) ABSTRACT

A network node (10) for switching digital information of different protocol types is described. The network node (10) comprises a plurality of modules (11). An arrangement of the modules (11) on the basis of a Banyan matrix type is provided. Control means are assigned to each module (11).

### DESCRIPTION

1. Prior Art

The invention is based on a network node for switching digital information of different protocol types with a plurality of modules. The invention likewise relates to a process for switching digital information of different protocol types in which a corresponding network node is provided.

It is known to use a so-called SDH switching matrix (SDH= synchronous digital hierarchy) for the synchronous switching of digital information packets. Such a SDH switching matrix contains a plurality of modules, each module being provided with a-plurality of so-called ports for incoming or outgoing information streams. In this way incoming information streams can be forwarded from each port of an input module to each port of an output module.

It is likewise known that so-called ATM or IP traffic (ATM= asynchronous transfer mode, IP=internet protocol) cannot readily be switched by such an SDH switching matrix. This is due i.a. to the different protocol types of the ATM and IP traffic, in particular to the asynchronous transmission thereof. Previously the resolution of this problem required additional ATM switches and IP routers connected to the SDH switching matrix. The amount of hardware complexity and resultant costs are clearly high.

2. Object and Advantages of the Invention

The object of the invention is to provide a network node for switching digital information of different protocol types which requires a low hardware outlay and consequently lower costs.

This object is achieved in a network node of the type referred to in the introduction, in accordance with the invention in that an arrangement of the modules on the basis of a Banyan matrix type is provided, and that each module is assigned control means for processing control information. In a process of the type referred to in the introduction, the object is achieved in accordance with the invention in that an arrangement of the modules on the basis of a Banyan matrix type is provided, that control information is added to the information, and that the information is processed by the network node as a function of the control information.

In the invention no additional ATM switches or IP routers are required. Due to the use of the Banyan matrix type it is possible to switch the SDH traffic, ATM traffic and IP traffic via one and the same network node according to the invention. This saves a considerable hardware outlay and therefore costs. In particular, the especially costly connections between the known SDH switching matrices and the additional ATM switches and IP routers are no longer necessary.

The network node according to the invention has no functional disadvantages. On the contrary, due to the use of the Banyan matrix type according to the invention a non-blocking network, which is readily capable of correctly switching synchronous SDH traffic and asynchronous ATM and IP traffic, is made available.

A further advantage of the invention consists in that a common clock can be used for all transmissions in the network node according to the invention. This simplifies the overall structure and mode of operation and leads to further reductions in costs.

The control information which in accordance with the invention is added to the information provides that in particular the SDH traffic is correctly switched by the network node. With the aid of the control information, the synchronous transmission of the SDH traffic and the correct forwarding thereof in the network node can be achieved in a simple manner.

In advantageous further developments of the invention, the connection of the two inputs to the two outputs of a module is controllable by the control means and/or the storage of information in storage means of a module is controllable by the control means. For this purpose the control information contains an item of destination information, as a function of which the information is forwarded in the individual modules. The control information likewise contains an item of storage information, as a function of which the information is intermediately stored in the individual modules.

It is particularly advantageous to provide a FIFO memory as storage means. On the one hand these are particularly cost-effective memories and on the other hand they automatically maintain the correct sequence of the stored information.

In an advantageous development of the invention, processing means are provided with which control information can be added to the information. In particular it is thereby possible for the control information to be generated for SDH traffic to be transmitted and for said control information to be added to the associated information.

This control information is checked by the control means of the individual modules. As a function of the control information, the control means then influence the mode of functioning of the respective modules. In particular, the control means control the forwarding of the information to be switched and/or the intermediate storage thereof as a function of the control information.

Further features, application possibilities and advantages of the invention are described in the following description of exemplary embodiments of the invention which are illustrated in the Figures of the drawing. Here all the described or represented features, both individually and in arbitrary combinations, form the subject of the invention irrespective of their combination in the claims or their dependencies and irrespective of their wording in the description and representation in the drawing.

### EXEMPLARY EMBODIMENTS OF THE INVENTION

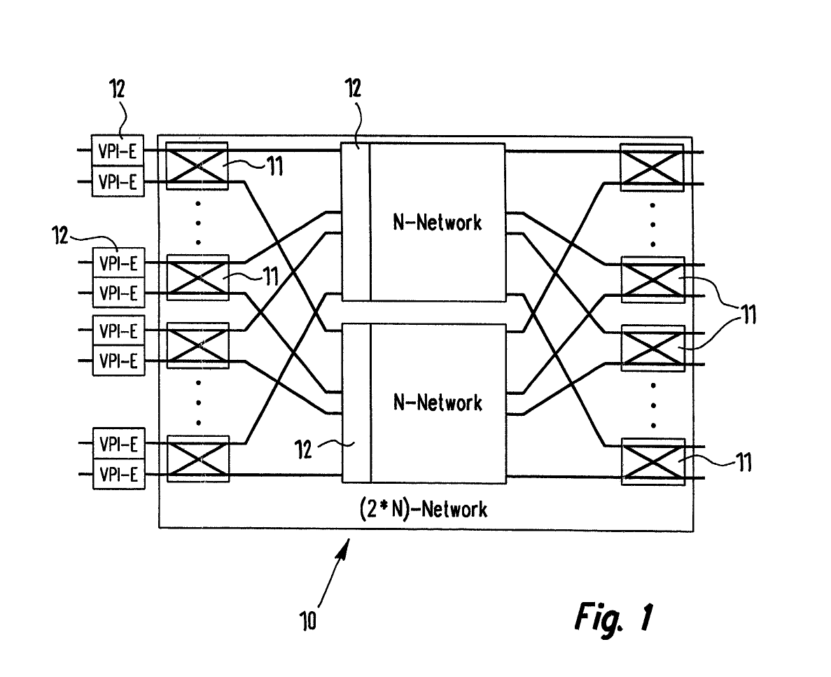

FIG. 1 is a schematic block diagram of an exemplary embodiment of a network node according to the invention;

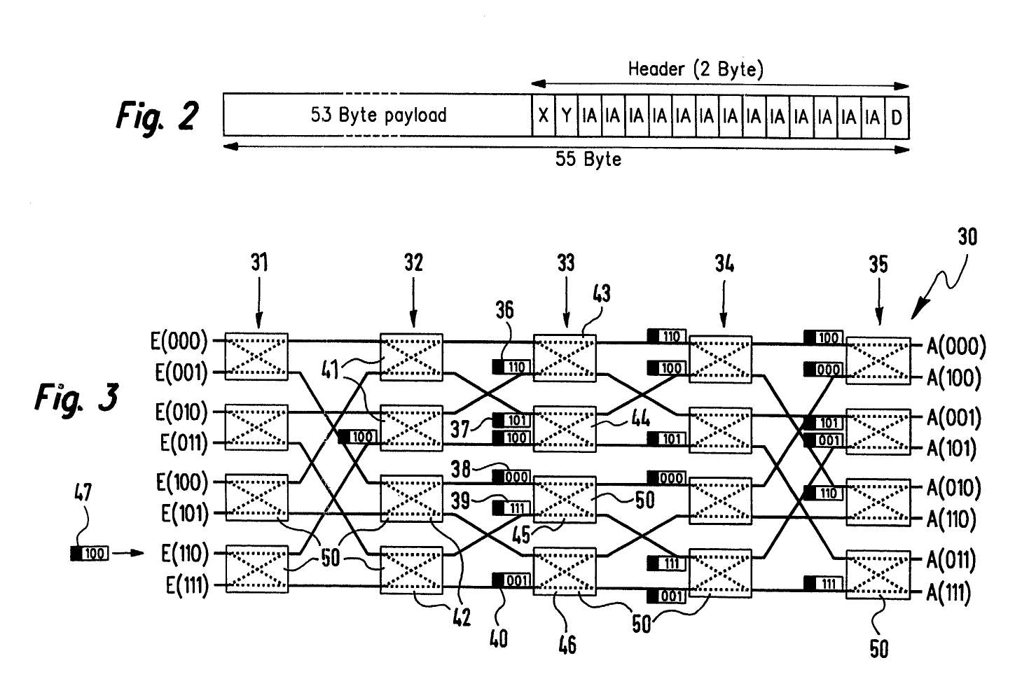

FIG. 2 is a schematic illustration of information according to the invention and

FIG. 3 is a schematic block diagram of a network node according to the invention with through-switched information.

FIG. 1 illustrates a network node 10 comprising a plurality of modules 11. The network node 10 has N inputs and N outputs also known as so-called ports. N is preferably a power of two. The individual modules 11 are so-called 2-networks which are combined to form two N-networks in the central area of FIG. 1 to simplify the drawing.

Each module 11, thus each 2-network, has two inputs and two outputs. Each of the two inputs can be connected to each of the two outputs. The modules 11 are arranged in stages. The network node 10 has M stages, where M=ld (N) with ld=logarithmus dualis.

The modules 11 of the consecutive stages of the network node 10 are arranged on the basis of a Banyan matrix type and are connected to one another. The meaning of this is as follows: The modules 11 of the second stage are divided into two groups. Of the outputs of the individual modules 11 of the first stage, the one output is in each case connected to a module of the one group of the second stage and the other output is connected to a module of the other group thereof. The modules of the third stage are divided into four groups of which two groups are in each case assigned to one of the groups of the second stage. The modules of the two groups of the second stage are then correspondingly connected to the modules of the associated groups of the third stage. This type of connection between the modules of the individual stages continues up to the last stage.

In the case of the above described network node 10 based on the Banyan matrix type, overall each of the inputs is connected to each of the outputs. Additionally this is a non-blocking network.

Control information is provided for controlling the information passing through the network node 10. This control information is added to the information. Each module 11 contains control means with which the control information of the relevant information is checked and the function of the module 11 is influenced in dependence thereupon.

The function of the module 11 here can be influenced by the control means in two different ways. On the one hand, in dependence upon the control information, information incoming at one of the two inputs can be forwarded to one of the two outputs of the module. On the other hand, incoming information can be intermediately stored in storage means of the module 11. Here the storage means consist in particular of a FIFO (first-in-first-out) memory.

In FIG. 2 digital information is shown in the form of an information packet consisting of two parts. A first part, which for example has a length of 53 bytes, contains a so-called payload. This comprises the data which a user wishes to transmit. A second part, which for example has a length of 2 bytes, contains a so-called header. This comprises the aforementioned control information. The total length of the information packet is thus 55 bytes.

The header of the information packet illustrated in FIG. 2 comprises a bit D representing an item of storage information. This bit D indicates whether the transmission is synchronous or asynchronous. The bit D thus characterises the type of connection, namely a so-called circuit switched connection or a so-called packet switched connection. If the bit D characterises an asynchronous transmission, the associated information packet can be intermediately stored by the module in the storage means. In the case of a synchronous transmission, intermediate storage is not possible. The decision on intermediate storage is made by the control means as a function of the bit D.

The header of the information packet shown in FIG. 2 also comprises a total of thirteen bits IA representing an item of destination information. The bits IA characterise the destination, i.e. the desired output of the network node 10 to be reached by the information packet.

Here a bit IA is provided as destination information for each stage of the right-hand half of the network node 10. With this bit IA the module 11 of the corresponding stage can decide to which of its two outputs the information packet is to be forwarded.

Overall thirteen bits IA are provided as destination information for the information packet shown in FIG. 2. As a result thirteen stages of the network node 10 can be controlled by the destination information. This is synonymous with a maximum of 8192 addressable outputs of the network node 10.

The header of the information packet shown in FIG. 2 also comprises two bits X and Y. These can be used for example for frequency tuning or other signal transmissions. Overall the control information of the header thus consists of the storage information, the destination information and the two bits X, Y.

The header, and thus the control information, of an information packet are created by processing means 12 in accordance with FIG. 1. These processing means 12 are so-called VPI evaluators (VPI=virtual path identifier). These processing means 12 can be provided singly for the entire network node 10. Preferably however the processing means 12 are multiply provided as is illustrated in FIG. 1.

In accordance with FIG. 1 a plurality of modules 11 are always combined, these then being assigned separate processing means 12. Thus in particular in FIG. 1 separate processing means 12 are in each case provided for the two N-networks. It is thus possible to arbitrarily extend the network node 10 by further modules 11 with associated processing means 12.

In the following, making reference to FIG. 3, it will be described how an information packet provided with corresponding control information is forwarded within a network node.

FIG. 3 illustrates a network node 30 comprising five stages 31, 32, 33, 34, 35. Each of the stages comprises three modules 50. The modules 50 shown in FIG. 3 correspond to the modules 11 of FIG. 1. The modules 50 of the network node 30 are arranged on the basis of a Banyan matrix type and are connected to one another. The modules 50 contain control means and storage means as described in association with FIG. 1.

On the left-hand side of FIG. 3 eight inputs of the network node 30 have been designated by “E” and an associated binary value. Similarly on the right-hand side of FIG. 3 eight outputs of the network node 30 have been designated by “A” and an associated binary value.

The first two stages 31, 32 of the network node 30 are used for the uniform distribution, the so-called balancing, of the incoming information packets between the following modules 50. The following three stages 33, 34, 35 of the network node 30 are used for the correct forwarding of the information packets, thus the so-called routing, to the outputs addressed by the destination information.

In the following the routing will firstly be explained in detail.

The centre of FIG. 3 shows an information packet 36 in the case of which the payload has been represented as a black area. The destination information associated with the information packet 36 is represented in the form of three bits IA. The other bits IA and the remaining bits of the header of the information packet 36 have not been shown.

In the case of the information packet 36 the bits “110” have been indicated as destination information. The information packet 36 thus is to be forwarded to the output A(110). The bits “110” of the destination information are checked by the control means of the modules 50 of the following stages 33, 34, 35 of the network node 30. As a result of the bits “110” the information packet 36 is forwarded from the uppermost module 50 of the stage 33 via the uppermost module 50 of the following stage 34 to the third module of the stage 35 and thus correctly to the output A(110). Here it should be noted that the bits of the destination information are processed from right to left by the control means. This means that as a result of the bit “0” the module 50 of the stage 33 is switched through by its control means to its upper output, while as a result of the two bits “1” the modules 50 of the following two stages 34, 35 are switched through by their control means to their lower outputs.

In FIG. 3 beneath the information packet 36 a further information packet 37 has been shown which has the bits “101” as destination information. This means that the information packet 37 is to be forwarded to the output A(101). As a result of the bits “101” of the destination information, the module 50 of the stage 33 is switched through by its control means to its lower output, while the module 50, connected to this lower output, of the next stage 34 is switched through by its control means to its upper output. Finally as a result of the last bit “1” of the destination information, the module 50, connected to the aforementioned upper output, of the stage 35 is again switched through by its control means to its lower output so that the information packet 37 finally correctly reaches the output A(101).

Similarly, an information packet 38 which has the bits “000” as destination information correctly reaches the output A(000).

Similar applies to an information packet 39 which has the bits “111” as destination information. In the stages 33, 34, 35 this information packet 39 is in each case forwarded to the lower output of the modules 50 so that the information packet 39 finally correctly reaches the output A(111).

In the case of a further information packet 40 which has the bits “001” as destination information, it should again be noted that the bits of the destination information are processed from right to left by the control means. This means that as a result of the bit “1” the module 50 of the stage 33 is switched through by its control means to its lower output while as a result of the two bits “0” the modules 50 of the following two stages 34, 35 are switched through by their control means to their upper outputs. Overall the information packet 40 thus correctly reaches the output A(001).

Each information packet 36, 37, 38, 39, 40 incoming at the stage 33 thus is checked by each of the modules 50 of the network node 30 in FIG. 3 in respect of its destination information and is forwarded as a function thereof. Additionally each incoming information packet 36, 37, 38, 39, 40 is also checked by the control means of the modules 50 in respect of its storage information. As a function thereof the information packet optionally is intermediately stored in the storage means of the relevant module 50.

The balancing will now be explained in detail.

In the modules 50 of the first stage 31 of the network node 30, incoming new information packets are distributed between the two upper modules 41 or the two lower modules 42 of the second stage 32. The distribution takes place on the one hand as a function of the destination information of the new information packets and on the other hand as a function of the destination information already present in the network node 30.

For this purpose it is checked how many items of destination information of information packets already present in the upper half of the network node 30 relate to the upper half of the outputs A and how many relate to the lower half. It is likewise checked whether the destination information of the new information packet incoming in one of the modules 50 of the first stage 21 relates to the upper half of the outputs A or to the lower half.

Then the following process is performed:

If, for the upper half of the outputs A, the number of items of destination information relating to this upper half of the outputs A exceeds the number of items of destination information relating to the lower half of the outputs A and if the destination information of the new information packet relates to the upper half of the outputs A, the new information packet is forwarded to one of the two lower modules 42 of the second stage 32.

If, for the upper half of the outputs A, the number of items of destination information relating to the upper half of the outputs A exceeds the number of items of destination information relating to the lower half of the outputs A, and if however the destination information of the new information packet relates to the lower half of the outputs A, the new information packet is forwarded to one of the two upper modules 41 of the second stage 32. Additionally in this case the number of items of destination information relating to the lower half of the outputs A is increased by one.

If however, for the upper half of the outputs A, the number of items of destination information relating to the upper half of the outputs A does not exceed the number of items of destination information relating to the lower half of the outputs A, and if the destination information of the new information packet relates to the upper half of the outputs A, the new information packet is forwarded to one of the two upper modules 41 of the second stage 32. Additionally in this case the number of items of destination information relating to the upper half of the outputs A is increased by one.

And if, for the upper half of the outputs A, the number of items of destination information relating to the upper half of the outputs A again does not exceed the number of items of destination information relating to the lower half of the outputs A, and if however the destination information of the new information packet relates to the lower half of the outputs A, the new information packet is forwarded to one of the two lower modules 42 of the second stage 32.

This process is performed in a corresponding manner in the second stage 32 where the new information packet is distributed from the two upper modules 41 of the second stage 32, in accordance with the described process, between the uppermost, first module 43 or the underlying second module 44 of the third stage 33. Likewise the new information packet is distributed from the two lower modules 42 of the second stage 32, in accordance with the described process, between the third module 45 or the underlying fourth module 46 of the third stage 33.

This process will be explained in detail again in the following in the form of an example.

It will be assumed that a new information packet 47 with the bits “100” arrives as destination information in the lowest module 50 of the first stage 31 of the network node 30. As a result of its destination information “100” the newly incoming information packet 47 relates to the upper half of the outputs A.

As shown in FIG. 3, five information packets 36, 37, 38, 39, 40 are present in the network node 30. Of these, in the upper half of the outputs A, the information packet 37 relates to the upper half of the outputs A and the information packet 36 relates to the lower half of the outputs A. Thus for the upper half of the outputs A, in respect of the modules 50 of the stages 31, 32, 33 the number of items of destination information relating to the upper half of the outputs A is equal to the number of items of destination information relating to the lower half of the outputs A.

This correspondence is determined by the lowest module 50 of the first stage 31. This module 50 also checks the destination information “100” of the newly incoming information packet 47. As a result of these items of information, the newly incoming information packet 47 is forwarded from the lowest module 50 of the first stage 31 to the upper half and thus to the second module 50 of the second stage 32.

Now the same process is performed in a corresponding manner by the second module 50 of the second stage 32. Here the process relates to the two upper modules 50 of the third stage 33. The upper half of these two modules 50, thus the uppermost module 50, only contains the information packet 36 with the destination information “110”. The number of items of destination information relating to the upper half of the two upper modules 50 thus exceeds the number of items of destination information relating to the lower half of these two modules 50.

The new information packet 47 also relates to the upper half of the two upper modules 50. In this way the new information packet 47 is forwarded from the second module 50 of the second stage 32 to the lower half of the two upper modules 50, thus to the module 44 of the third stage 33. From here it is then forwarded in accordance with its destination information “100” to the output A(100).

The network node 10, 30 described with reference to FIGS. 1 to 3, can transmit digital information of different protocol types. In particular, the network node 10, 30 is suitable for switching SDH traffic (SDH=synchronous digital hierarchy), ATM traffic (ATM=asynchronous transfer mode) and IP traffic (IP=internet protocol).

If SDH traffic is to be switched by the network node 10, 30, from the data additionally supplied by the SDH traffic the processing means 12 generates the control information required for the network node 10, 30, thus the headers for the information packets of the SDH traffic. As a result of the SDH traffic, the bit D of the storage information is set such that intermediate storage in the network node 10, 30 is not possible. The information packets of the SDH traffic thus are switched by the network node 10, 30 in synchronous manner.

If ATM traffic or IP traffic is to be switched by the network node 10, 30, the data of the ATM traffic or the IP traffic always comprise control information which largely corresponds to the control information required for the network node 10, 30. This control information is processed by the processing means 12 and accommodated in the headers of the information packets. The information packets are then fed to the network node 10, 30. As ATM traffic and IP traffic are synchronous transmissions, the bit D of the header is set such that intermediate storage in the network node 10, 30 is possible.

1. A network node (10, 30) for switching digital information of different protocol types with a plurality of modules (11, 50), characterised in that an arrangement of the modules (11, 50) on the basis of a Banyan matrix type is provided, and that each module (11, 50) is assigned control means for processing control information.

2. A network node (10, 30) according to claim 1, characterised in that each module (11, 50) has only two inputs and two outputs, where each of the two inputs can be connected to each of the two outputs.

3. A network node (10, 30) according to claim 2, characterised in that the connection of the two inputs to the two outputs of a module (11, 50) is controllable by the control means.

4. A network node (10, 30) according to one of claims 1 to 3, characterised in that the storage of information in storage means of a module (11, 50) is controllable by the control means.

5. A network node (10, 30) according to one of claims 1 to 4, characterised in that a FIFO memory is provided as storage means.

6. A network node (10, 30) according to one of claims 1 to 5, characterised in that processing means (12) are provided with which control information can be added to the information.

7. A network node (10, 30) according to claim 6, characterised in that the control means are dependent upon the control information.

8. A process for switching digital information of different protocol types wherein a network node (10, 30) with a plurality of modules (11, 50) is provided, characterised in that an arrangement of the modules (11, 50) on the basis of a Banyan matrix type is provided, that control information is added to the information, and that the information is processed by the network node (10, 30) as a function of the control information.

9. A process according to claim 8, characterised in that the control information contains an item of destination information, as a function of which the information is forwarded in the individual modules (11, 50).

10. A process according to one of claims 8 or 9, characterised in that the control information contains an item of storage information, as a function of which the information is intermediately stored in the individual modules (11, 50).

11. A process according to one of claims 8 to 10, characterised in that the control information is checked by control means of the individual modules (11, 50).
